(19) United States
(12) Patent Application Publication
(10) Pub. No.: US 2020/0189899 A1
(43) Pub. Date: Jun. 18, 2020

(54) FLUID DISPENSING DEVICE

(71) Applicant: Shu-Ling Lin, New Taipei City (TW)

(72) Inventor: Chih-Hsin Liang, Taichung City (TW)

(73) Assignee: Shu-Ling Lin, New Taipei City (TW)

(21) Appl. No.: 16/509,031

(22) Filed: Jul. 11, 2019

(30) Foreign Application Priority Data
Dec. 14, 2018 (TW) 107145238

(51) Int. Cl. B67D 1/00; B67D 1/08

(52) U.S. Cl. CPC B67D 1/0008; G01G 17/06; B67D 1/0889; B67D 1/0888

(57) ABSTRACT

A fluid dispensing device includes a housing unit, a storage unit and a discharge module that are disposed within the housing unit. A weighing module includes weighing sensors. Each weighing sensor has an attachment portion attached to a bottom wall of the housing unit, and an abutment portion disposed below the bottom wall oppositely to the attachment portion. A control module controls the discharge module to dispense predetermined amount of fluid outside of the housing unit. The control module is able to determine whether a weight of fluid in the storage unit is smaller than a predetermined value according to a weight of the housing unit measured by the weighing sensors.

### CROSS-REFERENCE TO RELATED APPLICATION

This application claims priority to Taiwanese Patent Application No. 107145238, filed on Dec. 14, 2018.

### FIELD

The disclosure relates to a dispensing device, and more particularly to a fluid dispensing device.

### BACKGROUND

An existing fluid dispensing device includes a housing, a fluid-storage barrel disposed in the housing and having a fluid-storage space, a dispensing module disposed in the housing and connected to the fluid-storage barrel, an input module disposed outside of the housing, a control module disposed in the housing and electrically connected to the input module and the dispensing module, and a capacitance liquid level gauge disposed in the housing and electrically connected to the control module.

The fluid-storage barrel further has a detection hole extending through bottom of the fluid-storage barrel in communication with the fluid-storage space. The capacitance liquid level gauge has an electric connection portion electrically connected to the control module, and a detection portion connected to the electric connection portion. The detection portion extends through the detection hole in contact with fluid in the fluid-storage space.

In use, the control module controls the dispensing module to discharge predetermined amount of the fluid according to a command inputted to the input module. Further, the control module is able to determine a height of the fluid in the fluid-storage barrel based on a capacitance value measured by the capacitance liquid level gauge, which can prompt a user to add appropriate amount of the fluid.

However, because the capacitance liquid level gauge directly contacts the fluid during measurement, a problem of poor hygiene may arise. If the detection hole is not sufficiently sealed, the fluid may leak. Besides, the capacitance liquid level gauge is only suitable to detect fluid having a relatively small consistency. If the capacitance liquid level gauge is used to detect fluid, such as fructose, that has a relatively high viscosity, poor accuracy may result.

Another fluid dispensing device has a structure similar to that of the aforesaid fluid dispensing device. However, it has a pressure sensor disposed below the fluid-storage barrel in the housing. According to a gravity change of the fluid-storage barrel applied to the pressure sensor, the pressure sensor is able to calculate a weight of the fluid in the fluid-storage barrel.

Although use of the pressure sensor can avoid the hygiene and accuracy problems caused by the capacitance liquid level gauge, the fluid-storage barrel has to be disposed in a movable manner along a gravity direction due to the limitation of the pressure sensor. During transportation, the fluid-storage barrel tends to repeatedly move upward and downward and impact the pressure sensor due to bumps in transportation roads. In addition, because the pressure sensor is disposed below the fluid-storage barrel inside the housing, it is difficult to cover the pressure sensor with a buffer material for reduction of impacts. Therefore, the fluid-storage barrel and the pressure sensor are easily damaged.

### SUMMARY

Therefore, an object of the disclosure is to provide a fluid dispensing device that is suitable for discharging and storing fluid and that can not only avoid hygiene and accuracy problems, but also alleviate damages during transportation.

According to the disclosure, a fluid dispensing device includes a housing unit, a storage unit, a discharge module, an input module, a weighing module and a control module.

The housing unit has a housing body, an inlet opening formed on the housing body, and an outlet opening spaced apart from the inlet opening. The housing body has a bottom wall, a surrounding wall extending upwardly from a periphery of the bottom wall, and a top wall connected to a top of the surrounding wall. The bottom wall, the surrounding wall and the top wall cooperatively define a receiving space in communication with the inlet opening and the outlet opening.

The storage unit is disposed within the receiving space. The storage unit includes a container and a fluid-storage space formed within the container. The fluid-storage space has a first opening communicated with the inlet opening, and a second opening spaced apart from the first opening.

The discharge module is disposed within the receiving space and is connected to the second opening. The discharge module is controllable to transport predetermined amount of fluid from the second opening to the outlet opening.

The input module is disposed outside of the housing body and is operable to input a command.

The weighing module includes a plurality of weighing sensors. Each of the weighing sensors has an attachment portion attached to the bottom wall, and an abutment portion disposed below the bottom wall oppositely to the attachment portion.

The control module is disposed within the receiving space, and electrically connected to the discharge module, the input module and the weighing module.

When the control module receives the command of the input module, the control module controls the discharge module to dispense predetermined amount of fluid outside of the housing unit from the second opening through the outlet opening.

The control module is able to determine whether a weight of fluid in the storage unit is smaller than a predetermined value according to a weight of the housing unit measured by the weighing sensors.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a fluid dispensing device according to the disclosure;

FIG. 2 is an exploded perspective of the embodiment;

FIG. 3 is an enlarged fragmentary exploded view illustrating a portion of the embodiment shown in FIG. 2;

FIG. 4 is a fragmentary side view of the embodiment, illustrating a base frame, a positioning unit, the fixing unit, the weighing sensor and the bottom wall of the fluid dispensing device; and

FIG. 5 is a block diagram of the embodiment, illustrating connection of a control module to a discharge module, an input module, a weighing module and a prompting module.

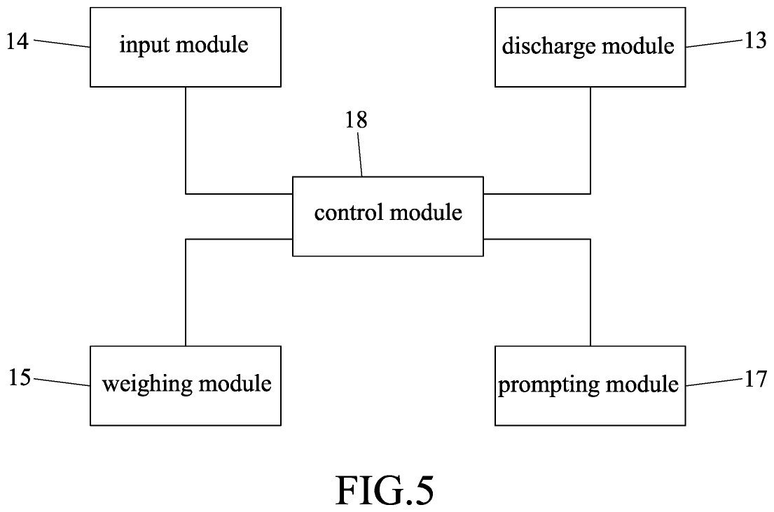

### DETAILED DESCRIPTION

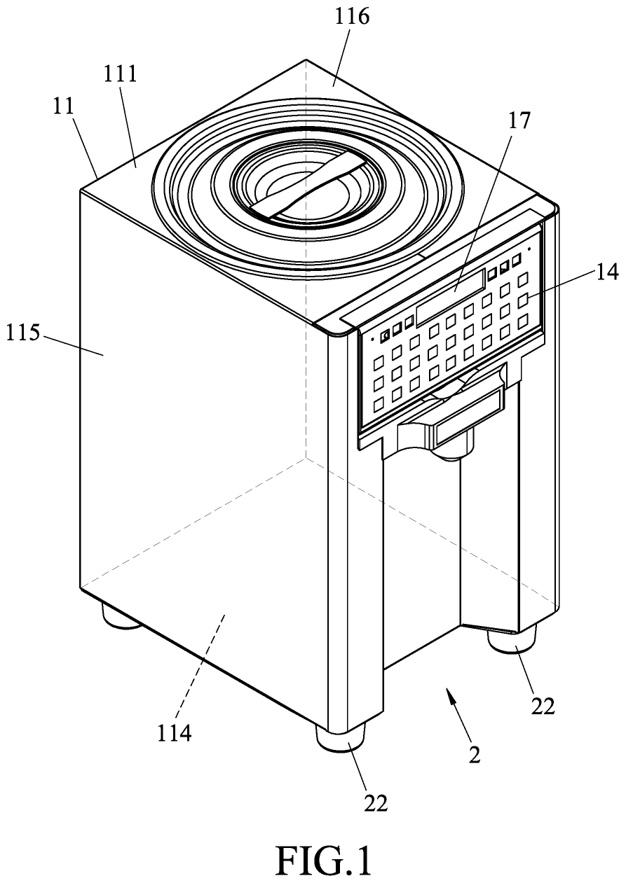

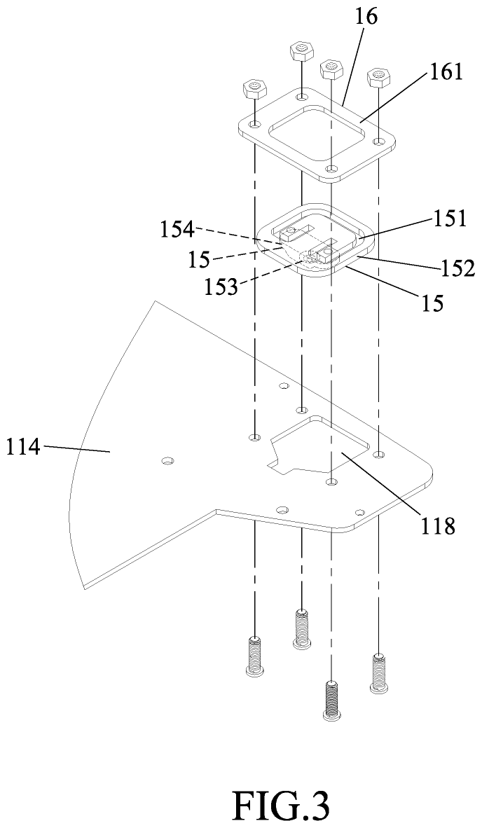

FIGS. 1 to 4 illustrate an embodiment of a fluid dispensing device according to the disclosure for discharging and storing fluid. The fluid dispensing device of the disclosure includes a housing unit 11, a storage unit 12, a discharge module 13, an input module 14, a weighing module 15, a fixing unit 16, a prompting module 17, a control module 18, a base frame 2 and a positioning unit 3.

The housing unit 11 has a housing body 111, an inlet opening 112 formed on the housing body 111, and an outlet opening 113 that is formed on the housing body 111 and that is spaced apart from the inlet opening 112.

The housing body 111 has a bottom wall 114, a surrounding wall 115 extending upwardly from a periphery of the bottom wall 114, and a top wall 116 connected to a top of the surrounding wall 115. The bottom wall 114, the surrounding wall 115 and the top wall 116 cooperatively define a receiving space 117 in communication with the inlet opening 112 and the outlet opening 113.

In this embodiment, although the inlet opening 112 is formed on the top wall 116 and the outlet opening 113 is formed on the surrounding wall 115, the fluid dispensing device of the disclosure is not limited thereto.

The bottom wall 114 of the housing unit 11 has four sensor holes 118 communicating with the receiving space 117, and four first positioning holes 119 extending therethrough.

The storage unit 12 is disposed within the receiving space 117. The storage unit 12 includes a container 121 and a fluid-storage space 122 formed within the container 121.

The fluid-storage space 122 has a first opening 124 communicated with the inlet opening 112, and a second opening 125 spaced apart from the first opening 124. In this embodiment, the storage unit 12 further includes a top cover 123 removably covering the first opening 124.

The discharge module 13 is disposed within the receiving space 117 and connected to the second opening 125 and the outlet opening 113. The discharge module 13 is controllable to transport predetermined amount of fluid from the second opening 125 to the outlet opening 113.

The input module 14 is disposed outside of the surrounding wall 115 above the outlet opening 113, and is operable to input a command.

The weighing module 15 includes four weighing sensors 151. Each weighing sensor 151 has an attachment portion 152 disposed within the receiving space 117 and on top of the bottom wall 114, an abutment portion 153 disposed below the bottom wall 114 oppositely to the attachment portion 152, and a connection portion 154 connected between the attachment portion 152 and the abutment portion 153. The connection portion 154 extends downwardly from the attachment portion 152 through a respecttive one of the sensor holes 118 to the abutment portion 153.

The fixing unit 16 has four fixing members 161 respectively fixing the attachment portions 152 of the weighing sensors 151 to the bottom wall 114. Each fixing member 161 includes a clamping plate 162 disposed on top of the attachment portion 152 of one of the weighing sensors 151, and fasteners 163 extending through the clamping plate 162 and the bottom wall 114 and fastening the clamping plate 162 to the bottom wall 114.

The prompting module 17 is disposed on an outer surface of the surrounding wall 115.

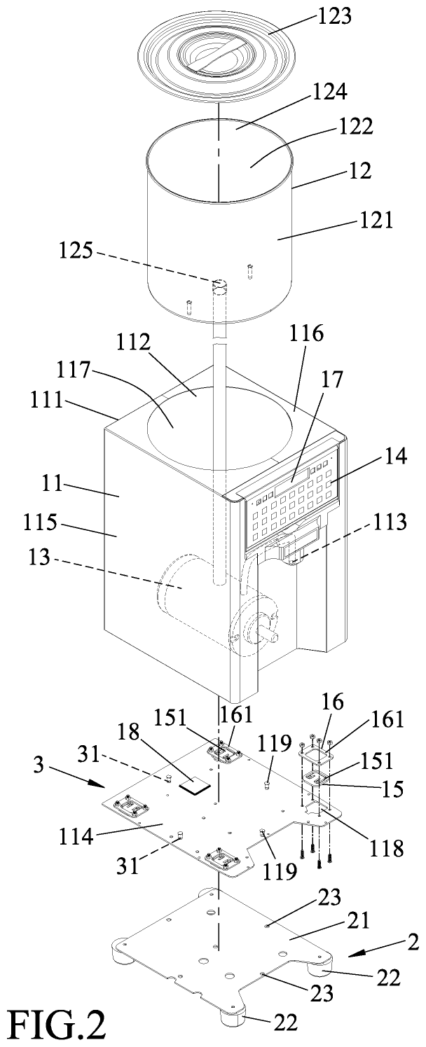

As shown in FIG. 2, the control module 18 is disposed within the receiving space 117, and is electrically connected to the discharge module 13, the input module 14, the weighing module 15 and the prompting module 17.

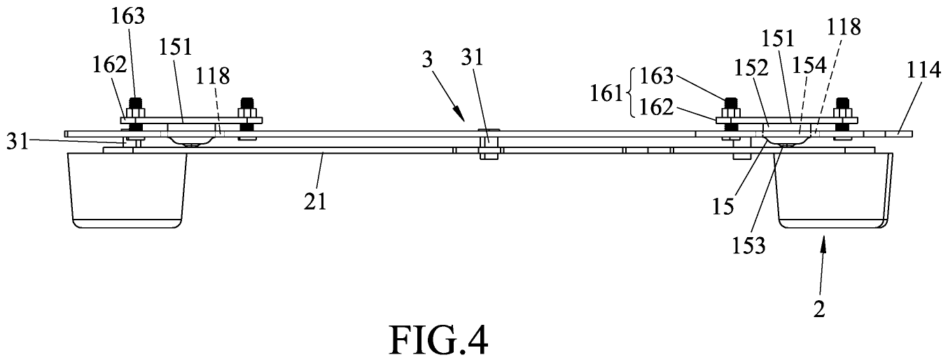

Referring back to FIGS. 2 and 4, the base frame 2 is disposed below and supports the housing unit 11 in a removable manner. The base frame 2 has a support wall 21, four support feet 22 connected to a bottom of the support wall 21, and four second positioning holes 23 respectively registered with the first positioning holes 119. The bottom wall 114 of the housing unit 11 is removably disposed on top of the support wall 21.

The positioning unit 3 includes four positioning members 31 each of which extends through one of the first positioning holes 119 and one of the second positioning holes 23.

In use, when the control module 18 receives the command of the input module 14, the control module 18 controls the discharge module 13 to dispense predetermined amount of fluid outside of the housing unit 11 from the second opening 125 through the outlet opening 113. The control module 18 is able to determine whether a weight of fluid in the storage unit 12 is smaller than a predetermined value according to a weight of the housing unit 11 measured by the weighing sensors 151. The control module 18 drives the prompting module 17 to present a prompt when the amount of fluid in the storage unit 12 is determined by the control module 18 to be smaller than the predetermined value.

In this embodiment, the prompt module 17 is a display screen. Alternatively, the prompt module 17 may be a prompt light device or a prompt sound device.

Notably, while the number of the weighing sensors 151 is four and the attachment portions 152 are attached to the bottom wall 114 in the receiving space 117, the number of the weighing sensors 151 can be two, three or greater than five, and the attachment portions 152 can be attached to bottom of the bottom wall 114 as long as the abutment portions 153 are disposed below the bottom wall 114 outside of the receiving space 117.

Further, the fluid dispensing device of the disclosure may not include the base frame 2 and the positioning unit 3. The housing unit 11 can be directly disposed on a flat surface to achieve the same effect.

Because the base frame 2 removably supports the housing unit 11, the housing unit 11 can be independently used from the base frame 2. The housing unit 11 can be separated from the base frame 2 during transportation of the fluid dispensing device of the disclosure. Because the abutment portion 153 of each weighing sensor 151 is below the bottom wall 114 outside of the housing unit 11, an impact-reducing material (not shown) can be used to cover the abutment portion 153 of each weighing sensor 151 for preventing damages caused by impacts.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A fluid dispensing device for discharging and storing fluid, comprising:
a housing unit having a housing body, an inlet opening formed on said housing body, and an outlet opening spaced apart from said inlet opening, said housing body having a bottom wall, a surrounding wall extending upwardly from a periphery of said bottom wall, and a top wall connected to a top of said surrounding wall, said bottom wall, said surrounding wall and said top wall cooperatively defining a receiving space in communication with said inlet opening and said outlet opening;
a storage unit disposed within said receiving space, said storage unit including a container and a fluid-storage space formed within said container, said fluid-storage space having a first opening communicated with said inlet opening, and a second opening spaced apart from said first opening;
a discharge module disposed within said receiving space and connected to said second opening, said discharge module being controllable to transport predetermined amount of fluid from said second opening to said outlet opening;
an input module disposed outside of said housing body and operable to input a command;
a weighing module including a plurality of weighing sensors, each of said weighing sensors having an attachment portion attached to said bottom wall, and an abutment portion disposed below said bottom wall oppositely to said attachment portion; and
a control module disposed within said receiving space, and electrically connected to said discharge module, said input module and said weighing module;
wherein, when said control module receives the command of said input module, said control module controls said discharge module to dispense predetermined amount of fluid outside of said housing unit from said second opening through said outlet opening;
wherein, said control module is able to determine whether a weight of fluid in said storage unit is smaller than a predetermined value according to a weight of said housing unit measured by said weighing sensors.

2. The fluid dispensing device as claimed in claim 1, wherein said bottom wall has a plurality of sensor holes communicating with said receiving space, each of said weighing sensors further having a connection portion connected between said attachment portion and said abutment portion, said attachment portion being disposed within said receiving space, said connection portion extending downwardly from said attachment portion through one of said sensor holes to said abutment portion.

3. The fluid dispensing device as claimed in claim 2, wherein the number of said weighing holes is four, the number of said weighing sensors being four, said fluid dispensing device further including a fixing unit that has four fixing members respectively fixing said attachment portions of said weighing sensors to said bottom wall.

4. The fluid dispensing device as claimed in claim 3, wherein said attachment portion of each of said weighing sensors is disposed on top of said bottom wall, each of said fixing members including a clamping plate disposed on top of said attachment portion of one of said weighing sensors, and a fastener extending through said clamping plate and said bottom wall and fastening said clamping plate to said bottom wall.

5. The fluid dispensing device as claimed in claim 1, further comprising a prompting module electrically connected to said control module, said control module driving said prompting module to present a prompt when the amount of fluid in said storage unit is determined by said control module to be smaller than the predetermined value.

6. The fluid dispensing device as claimed in claim 2, further comprising a base frame disposed below and supporting said housing unit, said base frame having a support wall and four support feet connected to a bottom of said support wall, said bottom wall of said housing unit being removably disposed on top of said support wall.

7. The fluid dispensing device as claimed in claim 6, wherein said bottom wall of said housing unit has four first positioning holes extending therethrough, said support wall of said base frame having four second positioning holes respectively registered with said first positioning holes, said fluid dispensing device further including four positioning members each of which extends through one of said first positioning holes and one of said second positioning holes.

8. The fluid dispensing device as claimed in claim 1, wherein said inlet opening is formed on said top wall of said housing unit, said outlet opening being formed on said surrounding wall of said housing unit.

9. The fluid dispensing device as claimed in claim 8 wherein said input module is disposed on said surrounding wall above said outlet opening.

10. The fluid dispensing device as claimed in claim 1, wherein said storage unit further includes a top cover removably covering said first opening.
